(19) United States
(12) Patent Application Publication
(10) Pub. No.: US 2007/0256890 A1
(43) Pub. Date: Nov. 8, 2007

(54) Safety harness with integrated ventral ascender

(75) Inventor: Paul Petzl, Barraux (FR)

Correspondence Address: OLIFF & BERRIDGE, PLC, P.O. BOX 19928, ALEXANDRIA, VA, 22320, US

(73) Assignee: ZEDEL, Crolles (FR)

(21) Appl. No.: 11/797,064

(22) Filed: Apr. 30, 2007

(30) Foreign Application Priority Data
May 2, 2006 (FR) 06/03921

(51) Int. Cl. A62B 35/00

(52) U.S. Cl. 182/3

(57) ABSTRACT

A roping harness for belaying when working at a height comprises a pair of leg loops, a belt equipped with a ventral attachment means, and a pair of shoulder straps joined to one another at the front by a fall-arrest safety chest attachment buckle which is located above the ventral attachment means. A ventral ascender is inserted between the ventral attachment means and the chest attachment buckle to achieve a strong link between the shoulder straps and the sit harness formed by the leg loops and the belt.

### BACKGROUND OF THE INVENTION

The invention relates to a roping harness for belaying when working at a height, comprising a pair of leg loops, a belt equipped with a ventral attachment means, and a pair of shoulder straps joined at the front by a fall-arrest safety chest attachment buckle which is located above the ventral attachment means.

### STATE OF THE ART

Safety roping harnesses for working at height have to comply with the work positioning safety standard EN358 and the fall arrest safety standard EN361. They generally comprise a ventral attachment point on the front of the belt, and a chest attachment point on the front of the chest. The ventral attachment point enables multiple work positioning configurations, and the chest attachment point is sufficiently high to prevent the user from toppling over backwards when suspended at the end of a fall. It is known to join the ventral attachment point to the chest attachment point by a webbing strap forming a strong link between the sit harness and the chest straps. Fitting an ascender operating in conjunction with the work rope is generally performed by fixing the ascender in parallel on the strap of the strong link between the chest point and the belt. The strength does not pass via the ascender which sometimes results in an uncomfortable positioning in suspension.

Certain known harnesses for caving use a single leg loop equipped with an ascender attached to a ventral attachment point and extended upwards by chest straps. This type of harness does not have an upper attaching point on the chest, which makes it unsuitable for ensuring safety in work at heights.

### OBJECT OF THE INVENTION

The object of the invention consists in providing a versatile roping harness of simple and compact structure, providing total safety and optimum comfort in all working at height situations.

The device according to the invention is characterized in that the ventral ascender is inserted between the ventral attachment means and the chest attachment buckle to achieve a strong link between the shoulder straps and the sit harness formed by the leg loops and the belt.

The ascender is thus integrated in the harness, performing, in addition to its function of securing on the work rope, an additional function of strong link between the ventral attachment means and the chest attachment buckle.

According to a preferred embodiment, the ascender comprises a front flange having a bottom hole connected to the ventral attachment means, and a top hole connected to the chest attachment buckle. The ascender can be of the trigger or cam type.

### BRIEF DESCRIPTION OF THE DRAWINGS

Other advantages and features will become more clearly apparent from the following description of a particular embodiment of the invention given as a non-restrictive example only and represented in the accompanying drawings, in which:

FIG. 1 is a schematic perspective view of the work harness with integrated ascender;

FIG. 2 shows an identical view to FIG. 1 of an alternative embodiment.

### DESCRIPTION OF A PREFERRED EMBODIMENT OF THE INVENTION

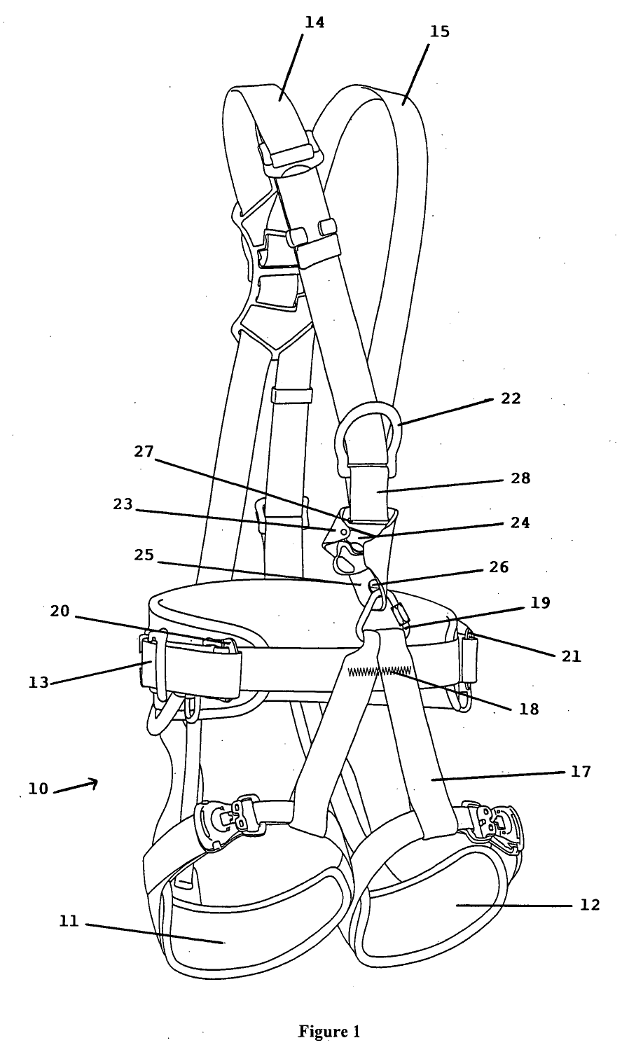

FIG. 1 shows a roping harness 10 used for work at heights and complying both with the work positioning safety standard EN358 and the fall arrest safety standard EN361. It is composed of a pair of leg loops 11, 12, a belt 13 and a pair of shoulder straps 14, 15. The two leg loops 11, 12 are joined to two front webbing straps 16, 17 sewn onto the front central part 18 of the belt 13. The belt 13 and leg loops 11, 12 are provided with an inside breathing padded foam lining providing maximum comfort in suspension.

The belt 13 is equipped with a ventral attachment means 19 formed by a buckle located directly above the front central part 18, and with two adjustment buckles 20, 21 arranged on the left and right sides for quick adjustment of the belt 13 to the user's morphology. The self-securing adjustment buckles can be of the type described in the document EP-A-569302.

The rear ends of the two shoulder straps 14, 15 are fixed to the rear part of the belt 13, for example by seams. The front ends of the shoulder straps 14, 15 are joined to one another on the chest forming a V connected to a chest attachment buckle 22.

The chest attachment buckle 22 constitutes an upper fall-arrest attachment point which ensures a correct position of the user after a fall has been arrested preventing any backward toppling movement. It is placed above the ventral attachment buckle 19, which constitutes a bottom attachment point enabling multiple work positioning configurations.

The two attachment buckles 22, 19 can cooperate respectively with a first safety rope equipped with a mobile fall-arrest device accompanying the worker's movements, and a second working rope associated with a progression and securing device.

According to the invention, a ventral ascender 23 acts as strong link between the chest attachment buckle 22 and the V of the shoulder straps 14, 15. The ascender 23 of known type with a pivoting securing trigger 24 described in the document FR-A-2568132 comprises a front flange 25 having a bottom hole 26 connecting with the ventral attachment buckle 19, and a top hole 27 in the form of a slit connecting with the chest attachment buckle 22 via a connecting strap 28.

The ascender 23 is thus integrated in the harness 10, performing, in addition to its function of securing on the work rope, an additional function of strong link between the ventral attachment buckle 19 and the chest attachment buckle 22.

Instead of an ascender 23 with a trigger 24, it is also possible to use a jamming cam ascender.

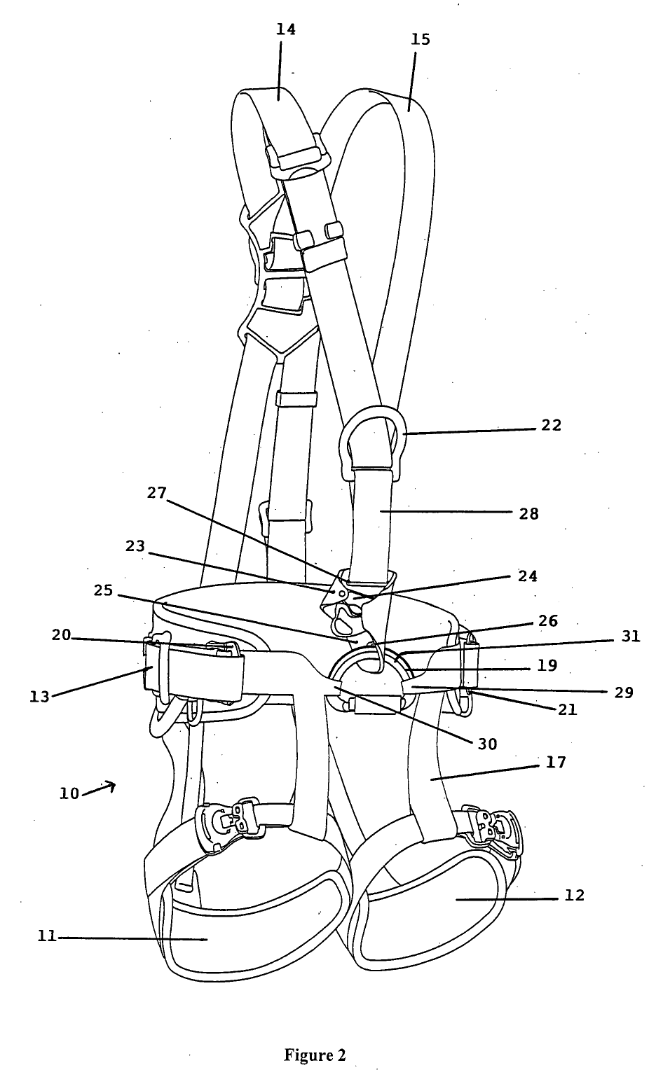

According to the alternative embodiment of FIG. 2, the belt 13 comprises two attachment loops 29, 30 at the front thereof, which loops are able to be joined to one another by a ring link 31 or a half-round carabiner in which the ascender 23 is attached.

1. Roping harness for belaying when working at height, comprising:
a pair of leg loops,
a belt equipped with a ventral attachment means,
and a pair of shoulder straps joined at the front by a fall-arrest safety chest attachment buckle which is located above the ventral attachment means,
wherein a ventral ascender is inserted between the chest attachment buckle and the ventral attachment means to achieve a strong link between the shoulder straps and the sit harness formed by the leg loops and the belt.

2. Roping harness according to claim 1, wherein the ascender comprises a flange having a bottom hole connected to the ventral attachment means, and a top hole connected to the chest attachment buckle.

3. Roping harness according to claim 2, wherein the top hole of the flange is in the form of a slit which is connected by a connecting strap to a chest attachment buckle.

4. Roping harness according to claim 1, wherein the ascender is of the pivoting securing trigger type.

5. Roping harness according to claim 1, wherein the ascender is of the jamming cam type.
